(19) United States
(12) Patent Application Publication
(10) Pub. No.: US 2016/0084196 A1
(43) Pub. Date: Mar. 24, 2016

(54) ENGINE RADIATION NOISE REDUCTION STRUCTURE

(71) Applicant: Hyundai Motor Company, Seoul (KR)

(72) Inventors: Seungwoo Lee, Seoul (KR); Bokyung Kim, Yongin (KR); Inwoong Lyo, Suwon (KR); Hongkil Baek, Seoul (KR); Jiyoun Seo, Suwon (KR)

(21) Appl. No.: 14/560,539

(22) Filed: Dec. 4, 2014

(30) Foreign Application Priority Data
Sep. 22, 2014 (KR) 10-2014-0126187

(51) Int. Cl. F02F 7/00; F02B 77/13; F02B 67/06; F02F 1/24

(52) U.S. Cl. CPC F02F 7/008; F02F 7/0085; F02F 1/24; F02B 77/13; F02F 7/0073; F02B 67/06

(57) ABSTRACT

An engine radiation noise reduction structure is provided. The engine radiation noise reduction structure includes a coating layer configured to absorb noise emitted from an engine and is formed on a high-temperature noise radiation part. The high-temperature noise radiation part includes an engine cover. In addition, coating layer includes polyamide imide resin and aerogel dispersed within the polyamide imide resin.

### CROSS-REFERENCE TO RELATED APPLICATION(S)

This application claims priority to and the benefit of Korean Patent Application No. 10-2014-0126187 filed on Sep. 22, 2014, the entire contents of which are incorporated herein by reference.

### BACKGROUND

1. Field of the Invention

The present invention relates to an automotive engine, and more particularly, to an engine radiation noise reduction structure which reduces noise emitted by absorbing noise energy that emits from an engine.

2. Description of the Related Art

In general, vehicles generate various noises. The noises generated by vehicles may be classified into noise generated by the engine system and noise generated by the exhaust system. In particular, the noise from the engine system is generated by explosion of fuel, friction, and vibration of parts. In addition, the noise becomes louder as the power and the revolutions per minute (RPM) of the engine increase.

Recently, noise regulations have been increasingly enforced and the technology to reduce noise generated by the engine has been developed. For example, the noise of the engine system is spread by high-temperature engine covers (e.g., radiation part), such as a timing chain cover and a cylinder head cover. Meanwhile, a sound-absorbing material, such as foam, is used to reduce noise of vehicles, but the foam may have a substantially low heat resistant temperature, so the application of foam to high-temperature engine covers may be difficult. In addition, the application of foam with a minimal thickness (e.g., thin) may also be difficult to apply to the engine covers. Further, the noise of an engine is partially reduced by increasing the rigidity of the engine covers, but the shape and structure of parts may need to be changed, which may increase the weight and the manufacturing cost of the parts of the engine.

This section is made to help understanding the background of the present invention and may include matters out of the related art known to those skilled in the art. The above information disclosed in this section is merely for the enhancement of understanding of the background of the invention and therefore it may contain information that does not form the prior art that is already known in this country to a person of ordinary skill in the art.

### SUMMARY

The present invention provides an engine radiation noise reduction structure which may reduce engine radiation noise by forming a coating layer that may absorb noise energy from high-temperature engine radiation parts.

An exemplary embodiment of the present invention provides an engine radiation noise reduction structure that may include a coating layer that may be formed on a high-temperature noise radiation part that may include a cover for an engine. In addition, the coating layer may be configured to absorb noise emitted from the engine, and may contain polyamide imide resin and aerogel dispersed within the polyamide imide resin. The coating layer may have thermal conductivity of about 0.60 watts per meter kelvin (W/m K) or less and heat capacity of about 1250 kilojoules per kelvin (KJ/K) or less. The polyamide imide resin of about 2 weight percent (wt %) or less may be dispersed within the aerogel. The polyamide imide resin may be disposed within a depth of about 5 percent (%) of the greatest (e.g., largest) diameter from the surface of the aerogel. The aerogel may have porosity from about 92% to about 99%, when being dispersed within the polyamide imide resin.

The coating layer may have a maximum thickness of about 10 millimeters (mm). In addition, the coating layer may contain the aerogel of about 5 to about 50 parts by weight to the polyamide imide resin of about 100 parts by weight. The aerogel may include at least one compound selected from the group consisting of: silicon oxide, carbon, polyimide, and metal carbide. The polyamide imide resin may be dispersed within a high-boiling point organic solvent or aqueous solvent (e.g. organic solvent or aqueous solvent that has a substantially high boiling point). Further, the aerogel may be dispersed within a low-boiling point organic solvent (e.g., an organic solvent that has a substantially low boiling point). The coating layer may be applied to an engine cover. The engine cover may be a timing chain cover or a cylinder head cover.

According to exemplary embodiments of the present invention, the engine radiation noise reduction structure may be applied to the engine cover that is a noise radiation part at a relatively high temperature, may reduce the level of noise emitted to the exterior from an engine by absorbing noise energy emitted from the engine, and may improve an efficiency of the engine and fuel efficiency of a vehicle by reducing thermal energy that escapes from the engine. Further, engine radiation noise may be reduced without changing the rigidity, shape, and structure of the engine cover. In addition, the weight of an engine and manufacturing cost may decrease.

### BRIEF DESCRIPTION OF THE DRAWINGS

The drawings are provided for reference in describing exemplary embodiments of the present invention and the spirit of the present invention should not be construed only by the accompanying drawings:

FIG. 1 is an exemplary view showing an example of an engine radiation noise reduction structure according to an exemplary embodiment of the present invention;

FIG. 2 is an exemplary picture showing the surface of an insulation coating layer according to an exemplary embodiment of the present invention; and

FIG. 3 is an exemplary picture showing the surface of an insulation coating layer according to the related art.

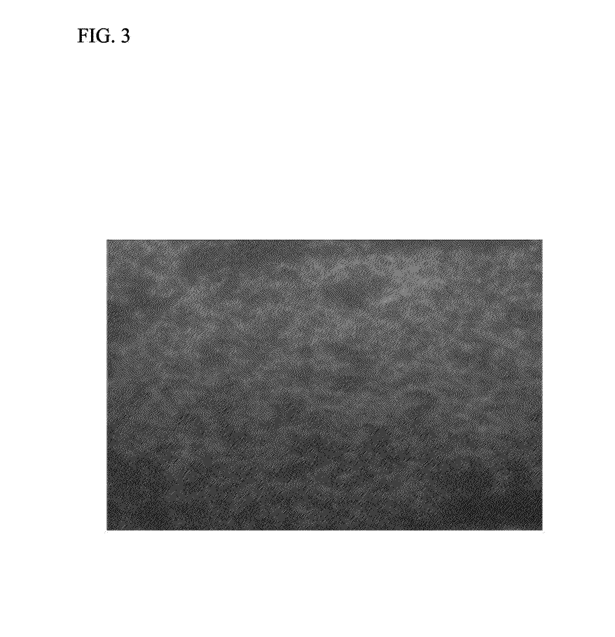

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

The present invention will be described more fully hereinafter with reference to the accompanying drawings, in which exemplary embodiments of the invention are shown. As those skilled in the art would realize, the described exemplary embodiments may be modified in various different ways, all without departing from the spirit or scope of the present invention.

The parts not related to the description of the exemplary embodiments are not shown to make the description clear and like reference numerals designate like elements throughout the specification. Further, the sizes and thicknesses of the configurations shown in the drawings are provided selectively for the convenience of description, so that the present invention is not limited to those shown in the drawings and the thicknesses are exaggerated to make some parts and regions clear.

Discriminating the names of components with the first, and the second, etc. in the following description is for discriminating them for the same relationship of the components and the components are not limited to the order in the following description. Further, the terms, “ . . . unit”, “ . . . mechanism”, “ . . . portion”, “ . . . member” etc. used herein mean the units of inclusive components performing at least one or more functions or operations.

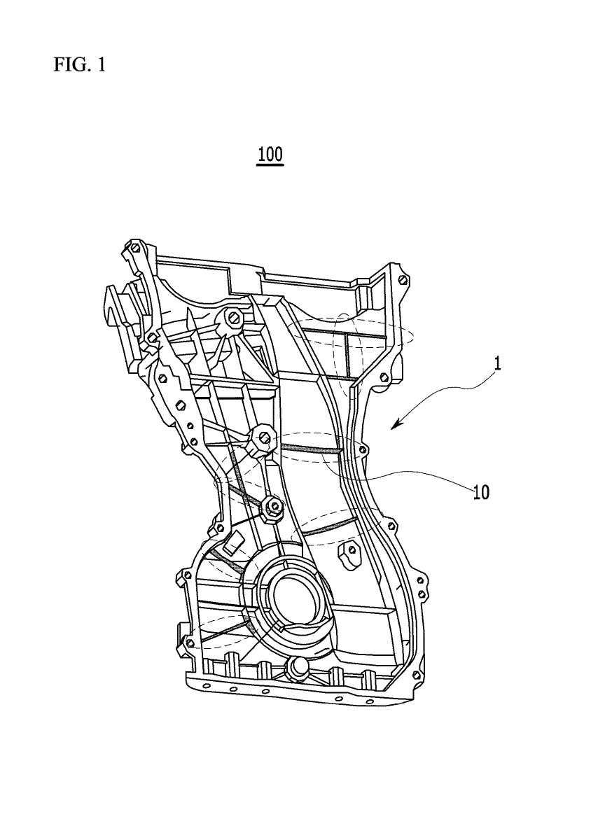

FIG. 1 is an exemplary view showing an example of an engine radiation noise reduction structure according to an exemplary embodiment of the present invention. Referring to FIG. 1, an engine radiation noise reduction structure 100 according to an exemplary embodiment of the present invention may be applied to noise radiation parts, which may emit internal noise of an engine, at a substantially high temperature. For example, the substantially high-temperature noise radiation part may a substantially high-temperature part of an engine and may include an engine cover 1 (e.g., a timing chain cover, a timing belt cover, and a cylinder head cover). However, the scope of the present invention is not necessarily limited to the engine cover 1 and the spirit of the present invention may be applied to various types of engine parts that emit noise from an engine.

The engine radiation noise reduction structure 100 according to an exemplary embodiment of the present invention may have a structure that is capable of reducing engine radiation noise by applying a coating material that may absorb noise energy to the engine cover 1. In particular, the engine radiation noise reduction structure 100 may include a coating layer 10 formed throughout (e.g., on every part of) the engine cover 1 or on a predetermined noise radiation portion. In other words, the coating layer 10 may be coated partially on or completely on a part or component that may emit noise such as a crank pulley or a fastening portion of the engine cover 1.

The coating layer may be made of a coating composition that may absorb noise energy emitted from within an engine and may maintain high mechanical properties, high heat resistance, high high-temperature durability, low thermal conductivity, and low volume heat capacity. In addition, the coating composition may improve engine and fuel efficiency of a vehicle by reducing thermal energy emitted to the exterior of the engine (e.g. outside of the engine). As shown in FIG. 1, although the coating layer 10 is partially coated on the inner side of the engine cover 1, the present invention is not limited thereto and the coating layer 10 may be coated throughout the inner side of the engine cover 1.

Hereinafter, the coating layer 10 according to an exemplary embodiment of the present invention and the coating composition of the coating layer 10 will be described in more detail. An exemplary embodiment of the present invention provides a coating composition that may include a polyamide imide resin dispersed within a high-boiling point organic solvent or aqueous solvent and an aerogel dispersed within a low-boiling point organic solvent. Further, the coating layer 10 according to an exemplary embodiment of the present invention may include polyamide imide resin and aerogel dispersed within the polyamide imide resin. In addition, the coating layer may have a thermal conductivity of about 0.60 watts per meter (W/m) or less.

When a coating composition obtained by dispersing polyamide imide resin and aerogel within predetermined solvents, respectively, and the coating layer 10 are applied to a high-temperature engine noise radiation part, lower thermal conductivity, substantially low density, and substantially high mechanical properties and heat resistance may be produced. In addition, radiation noise of an engine may be reduced and an internal combustion engine and fuel efficiency of a vehicle may increase by reducing thermal energy radiated to the exterior of the engine. Further, when the coating layer 10 with a substantially small thickness (e.g., substantially thin) is applied to the engine cover 1, radiation noise of an engine may be reduced without changing the rigidity, shape, and structure of the engine cover.

Recently, methods of using aerogel (e.g., air-gel) for members (e.g., an insulator, a shock-absorbing member, or a soundproofing member) have been proposed. The aerogel may have a structure composed of micro fibers that has a thickness of one over ten thousand (1/10,000) of a hair and a porosity of about 90% or greater. In addition, the aerogel may be made of one selected from the group consisting of: silicon oxide, carbon, metal carbide, and an organic polymer. In particular, the aerogel may have a high light transmittance and substantially low thermal conductivity due to the structural features described above.

However, the aerogel may have a substantially low strength. For example, the aerogel may be broken by a substantially small shock (e.g., force) due to high brittleness and may be difficult to manufacture at various thicknesses and into various shapes, so the aerogel may not be effectively used as an insulator despite having excellent insulating properties. Further, when the aerogel is mixed with another reactant, a solvent or a solute may permeate into the aerogel and increase viscosity of the compound, so the mixing may not be practical. Accordingly, the aerogel may be difficult to combine, or mix, with another material and may lose the properties of the porous aerogel when mixed with another material. Alternatively, when the polyamide imide resin is dispersed within a high-boiling point organic solvent or aqueous solvent and the aerogel is dispersed within a low-boiling point organic solvent, the dispersion of the polyamide imide resin and the aerogel within the solvent may be substantially uniformly mixed without conglomerating (e.g., clustering) and the coating composition may have a substantially uniform composition.

Further, since the high-boiling point organic solvent or aqueous solvent and the low-boiling point organic solvent may not be easily dissolved into or mixed with each other, the polyamide imide resin and the aerogel may mix with each other and form a coating composition. Accordingly, direct contact between the polyamide imide resin and the aerogel before the coating composition is applied and dried may be minimized. Additionally, the polyamide imide resin may not permeate into or impregnate the aerogel. Further, the low-boiling point organic solvent may have predetermined affinity to the high-boiling point organic solvent or aqueous solvent, so the aerogel dispersed within the low-boiling point organic solvent may be substantially mixed with the polyamide imide resin and substantially uniformly distributed. In addition, the predetermined affinity may substantially uniformly distribute the polyamide imide resin within the high-boiling point organic solvent or aqueous solvent.

Accordingly, the coating layer 10 may have properties that are equivalent to or greater than the properties of the aerogel. Further, the aerogel may be more uniformly dispersed within the polyamide imide resin, so the insulating features (e.g., high mechanical properties, heat resistance, and high-temperature durability) may be improved. In other words, high mechanical properties, high heat resistance, high high-temperature durability, low thermal conductivity, and low density may be maintained since the coating layer 10 may maintain properties and a structure of the aerogel. Further, engine and fuel efficiency of a vehicle may be increased by reducing thermal energy emitted from the engine cover 1.

Furthermore, engine radiation noise may be reduced by absorbing noise energy emitted to the exterior of the engine through the engine cover 1 since the coating layer 10 obtained from the coating composition of the exemplary embodiment may maintain properties and a structure at the equivalent level to those of the aerogel. In addition, the coating layer 10 may reduce radiation noise of an engine which is emitted through an engine cover 1, with a minimal thickness (e.g., substantially thin) without changing the rigidity, shape, and structure of the engine cover 1.

The coating layer 10 may be applied to a portion of the engine cover 1, which faces main components of an engine, or the whole (e.g., cover every part of) engine cover 1. The coating composition may be produced by mixing the polyamide imide resin dispersed within the high-boiling point organic solvent or aqueous solvent with the aerogel dispersed within the low-boiling point organic solvent. The mixing method is not necessarily limited and physical mixing methods generally known in the art may be used. For example, mixing two types of solvent dispersion phases, adding zirconia beads to the mixture, and performing ball-milling at a substantial room temperature and at a speed of about 100 revolutions per minute (rpm) to about 500 rpm under a normal pressure may be used. However, the method of mixing the solvent dispersion phases of the polyamide imide resin and the aerogel may not be limited to the example.

The coating composition may provide an insulating material or structure that may be maintained for a substantially long period of time within an engine, when high-temperature and high-pressure conditions are applied repeatedly. In particular, the coating composition may be used to coat an inner side of an engine or the parts of an engine and may also be used for parts of an engine cover to reduce the noise emitted by the engine.

The polyamide imide resin that may be contained in the coating composition of an exemplary embodiment is not necessarily limited, but the polyamide imide resin may have a weight-average molecular weight of about 3,000 to about 300,000 or about 4,000 to about 100,000. When the weight-average molecular weight of the polyamide imide resin is light (e.g., less than a predetermined weight), sufficient mechanical properties, heat resistance, high-temperature durability, insulating ability, and noise-absorbing ability of a coating layer or a coating film may not be produced.

Further, when the weight-average molecular weight of the polyamide imide resin is substantially heavy (e.g., greater than a predetermined weight), uniformity (e.g., homogeneity) of a coating layer or a coating film obtained from a coating composition and the dispersion ability of aerogel in a coating composition may decrease. Further, when a coating composition is applied, the nozzle of the applying device may be clogged and the time to perform heat treatment on a coating composition and the heat treatment temperature may increase.

Aerogel that is generally known may be used as the aerogel described above, and more particularly, aerogel that contains silicon oxide, carbon, polyimide, metal carbide or a combination thereof may be used. The aerogel may have a specific surface area of about 100 centimeters cubed per gram (cm³/g) to about 1,000 cm³/g, or more specifically, about 300 cm³/g to about 900 cm³/g. In addition, the coating composition may contain an aerogel of about 5 parts by weight to about 50 parts by weight or more specifically, about 10 to about 45 parts by weight to polyamide imide resin of 100 parts by weight. The weight ratio of the polyamide imide resin and the aerogel may be the weight ratio of solid to the dispersion solvents.

When the content of the aerogel to the polyamide imide resin is minimal (e.g., insufficient), the thermal conductivity and density of a coating layer or a coating film obtained from a coating composition may not decrease. In addition, sufficient insulating ability may not be produced and heat resistance of a coating layer made of a coating composition may reduce. Further, when the content of the aerogel to the macromolecular resin is substantially large, sufficient mechanical properties of a coating layer or a coating film may not be produced, cracks may be generated in a coating layer made of a coating composition, and the shape of the coating layer may be difficult to maintain.

The content of the solid of the polyamide imide resin within the high-boiling point organic solvent or aqueous solvent is not necessarily limited, but the content of the solid may be about 5 wt % to about 75 wt % in consideration of uniformity or properties of a coating composition. Further, the content of the solid of the aerogel within the low-boiling point organic solvent is not necessarily limited, but the content of the solid may be about 5 wt % to about 75 wt % in consideration of uniformity or properties of a coating composition.

As described above, since the high-boiling point organic solvent or aqueous solvent and the low-boiling point organic solvent are not easily dissolved or mixed to each other, direct contact between the polyamide imide resin and the aerogel may be minimized before the coating composition of an exemplary embodiment is applied and dried. In addition, the polyamide imide resin may not permeate into or impregnate the aerogel or pores. In particular, the difference in boiling point between the high-boiling point organic solvent and the low-boiling point organic solvent may be about 10° C. or greater, and more specifically, about 20° C. or greater, and even more specifically, about 10° C. to 200° C. The high-boiling point organic solvent may be an organic solvent that has a boiling point of about 110° C. or greater.

The high-boiling point solvent may be at least one selected from the group consisting of: anisole, toluene, xylene, methyl ethyl ketone, methyl isobutyl ketone, ethylene glycol monomethyl ether, ethylene glycol monoethyl ether, ethylene glycol monobutyl ether, butyl acetate, cyclohexanone, ethylene glycol monoethyl ether acetate (BCA), benzene, hexane, DMSO, N,N′-Dimethyl formaldehyde, and a combination thereof. The low-boiling point organic solvent may be an organic solvent that has a boiling point less than about 110° C. The low-boiling organic solvent may be at least one selected from the group consisting of: methyl alcohol, ethyl alcohol, propyl alcohol, n-butyl alcohol, iso-butyl alcohol, tert-butyl alcohol, acetone, methylene chloride ethylene acetate, isopropyl alcohol, and a combination thereof. Alternatively, the aqueous solvent may be at least one selected from the group consisting of: water, methanol, ethanol, ethyl acetate, and a combination thereof.

Further, according to another exemplary embodiment of the present invention, a coating layer 10 that contains polyamide imide resin and aerogel dispersed within polyamide imide resin and has thermal conductivity of about 0.60 W/m or less may be provided. The coating layer 10 may produce a low thermal conductivity, low density, high mechanical properties, high heat resistance, high high-temperature durability. Further, the coating layer 10 may absorb and reduce radiation noise of an engine when applied to the engine cover 1, and may also improve an engine and fuel efficiency of a vehicle. Further, a coating layer 10 that may reduce radiation noise from an engine with a minimum thickness and may not change the rigidity, shape, and structure of the engine cover 1 is provided.

Within the coating layer 10, aerogel may be substantially uniformly dispersed throughout polyamide imide resin, so the properties of the aerogel (e.g., low thermal conductivity and low density) and polyamide imide resin (e.g., high mechanical properties, heat resistance, and high-temperature durability may be reproduced) engine radiation noise may be more easily absorbed. The coating layer 10 may have a substantially low thermal conductivity and high heat capacity. In particular, the coating layer 10 may have thermal conductivity of about 0.60 watts per meter (W/m) or less, and more specifically, about 0.55 W/m or less, and even more specifically, about 0.20 W/m to 0.60 W/m and a heat capacity of about 1250 kilojoules per kelvin (KJ/K) or less, and more specifically, about 1000 KJ/K to about 1250 KJ/K.

Alternatively, since the coating composition contains polyamide imide resin dispersed within a high-boiling point organic solvent or aqueous solvent and aerogel dispersed within a low-boiling point organic solvent and may minimize direct contact between the polyamide imide resin and the aerogel, the polyamide imide resin may not permeate into or impregnate the aerogel or pores in the resultant coating layer 10 before the coating composition is applied and dried. In particular, polyamide imide resin may not substantially exist within the aerogel, and for example, polyamide imide resin of about 2 wt % or less, and more specifically, about 1 wt % or less may exist within the aerogel.

Further, the aerogel may be dispersed within the polyamide imide resin within the coating layer 10, but the polyamide imide resin may not be dispersed within the aerogel. In particular, the polyamide imide resin may not be disposed to a depth greater than about 5% of a largest diameter from the surface of the aerogel within the coating layer 10. In other words, the polyamide imide resin may be dispersed at a depth of about 5% of the largest diameter from the surface of the aerogel within the coating layer 10. Since the polyamide imide resin does not permeate or is not impregnated into the aerogel or the pores, the aerogel may have about the same level of porosity before and after dispersion within the polyamide imide resin. In particular, the aerogel contained within the coating layer 10 may have porosity of about 92% to about 99% when dispersed within the polyamide imide resin.

The coating layer 10 of an exemplary embodiment may provide an insulating material or an insulating structure that may be maintained for a substantially long period of time within an engine where high-temperature and high-pressure conditions may be repeatedly applied. In particular, the coating layer 10 may be used for an inner side of an engine or the parts of an engine. The thickness of the coating layer 10 of an exemplary embodiment may depend on the part or the position to which it is applied or requested properties, and may be about 10 mm at a maximum, (e.g., about 50 micrometers (μm) to about 500 μm). The coating layer 10 of an exemplary embodiment may contain aerogel of about 5 part by weight to about 50 part by weight, and more specifically, about 10 part by weight to about 45 part by weight to polyamide imide resin of about 100 part by weight.

When the content of the aerogel to the polyamide imide resin is minimal (e.g., insufficient), the thermal conductivity and density of a coating layer may not be reduced or engine radiation noise may not be dissipated. In addition, sufficient insulating ability may not be produced, and the heat resistance and high-temperature durability of a coating may decrease. Further, when the content of the aerogel to the polyamide imide resin is excessive (e.g., greater than a predetermined amount), mechanical properties of a coating layer may not be reproduced, cracks may be generated within a coating layer, and the shape of the coating layer may be difficult to be maintain. The polyamide imide resin may have weight-average molecular weight of about 3,000 to about 300,000, and more particularly, about 4,000 to about 100,000. The aerogel may include at least one selected from the group consisting of: silicon oxide, carbon, polyimide, and metal carbide. The aerogel may have a specific surface area of about 100 cm³/g to about 1,000 cm³/g.

The coating layer 10 may be obtained by drying the coating composition. The apparatus or the method that may be used to dry the coating composition of an exemplary embodiment is not necessarily limited, but of the coating composition may be naturally dried at a room temperature or greater or heated at a temperature of about 50° C. For example, the coating layer 10 may be formed by coating the outer side of the engine cover 1 with the coating composition, a first drying at a temperature of about 50° C. to about 200° C., and a second drying the coating composition at a temperature of about 200° C. or greater. However, the detailed method of manufacturing the coating layer according to an exemplary embodiment is not limited thereto. The present invention will be described in more detail with reference to the following exemplary embodiments. However, the following exemplary embodiments are only examples of the present invention and the present invention is not limited to the exemplary embodiments.

### Exemplary Embodiment 1 to 3

### 1. Production of Coating Composition

A coating composition (e.g., coating solution) was produced by injecting porous silica aerogel, having a specific surface area of about 500 cm³/g, dispersed within ethyl alcohol and polyamide imide resin dispersed within xylene into a 20 g-reactor, adding zirconia beads, and performing ball-milling at a room temperature and at a speed of about 150 rpm to about 300 rpm under a normal pressure. The weight ratio of the porous silica aerogel to the polyamide imide resin may be as shown in the following Table 1.

### 2. Forming of Coating Layer

The obtained coating composition was applied to an engine cover that is a high-temperature engine noise radiation part using a spray coating method. Further, the coating composition was applied to the part. The coating composition was applied by primary half-drying at about 150° C. for about 10 minutes, and then the coating composition was applied again, and secondary half-drying at 150° C. for about 10 minutes. A coating layer was formed on the part by applying the coating composition again, and then performing complete drying at about 250° C. for about 60 minutes. The thickness of the formed coating layer may be as shown in the following Table 1.

### Comparative Example 1

A solution of polyamide imide resin (PAI solution) dispersed within xylene was applied to an engine cover in a spray coating method. The PAI solution was applied to the part, primary half-dried performed at about 150° C. for about 10 minutes, and then the PAI solution was applied again, and secondary half-dried at about 150° C. for about 10 minutes. A coating layer was formed on the part by applying again the PAI solution, and completely dried at about 250° C. for about 60 minutes. The thickness of the formed coating layer may be as shown in the following Table 1.

### Comparative Example 2

### 1. Production of Coating Composition

A coating composition (e.g., coating solution) was produced by injecting porous silica aerogel and polyamide imide resin dispersed within xylene into a 20 g-reactor, adding zirconia beads, and performing ball-milling at a room temperature and at a speed of about 150 rpm to about 300 rpm under a normal pressure. The weight ratio of the porous silica aerogel to the polyamide imide resin may be as shown in the following Table 1.

### 2. Forming of Coating Layer

A coating layer having a thickness of about 200 μm was formed in the same way as described in Exemplary embodiment 1.

### Experimental Example

### 1. Experimental Example 1

### Measurement of Thermal Conductivity

Thermal conductivity was measured by performing a thermal diffusivity method on the coating layers on the parts obtained in Exemplary Embodiments and Comparative Examples, using a laser flash method at a room temperature and at normal pressure on the basis of ASTM E1416.

### 2. Experimental Example 2

### Measurement of Heat Capacity

Heat capacity of the parts obtained in Exemplary Embodiments and Comparative Examples was determined by measuring specific heat with a sapphire as a reference, using a DSC apparatus at a room temperature on the basis of ASTM E1269.

TABLE 1

| | Content of | | | Heat |
|---|---|---|---|---|
| | Aerogel to | Thickness | Thermal | Capacity |
| | PAI Resin of | of | Conductivity | of |
| | 100 Part by | Coating | of Coating | Coating |
| | Weight (Part | Layer | Layer | Layer |
| | by Weight) | (μm) | (W/m) | [KJ/K] |
| Exemplary | 15 | 120 | 0.54 | 1216 |
| Embodiment 1 | | | | |
| Exemplary | 20 | 200 | 0.331 | 1240 |
| Embodiment 2 | | | | |
| Exemplary | 40 | 200 | 0.294 | 1124 |
| Embodiment 3 | | | | |
| Comparative | — | 200 | 0.56 | 1221 |
| Example 1 | | | | |

As shown in Table 1, the coating layers obtained in Exemplary Embodiment 1 to 3 may have a heat capacity of about 1240 KJ/K or less and a thermal conductivity of about 0.54 W/m or less, when the thickness is about 120 μm to 200 μm.

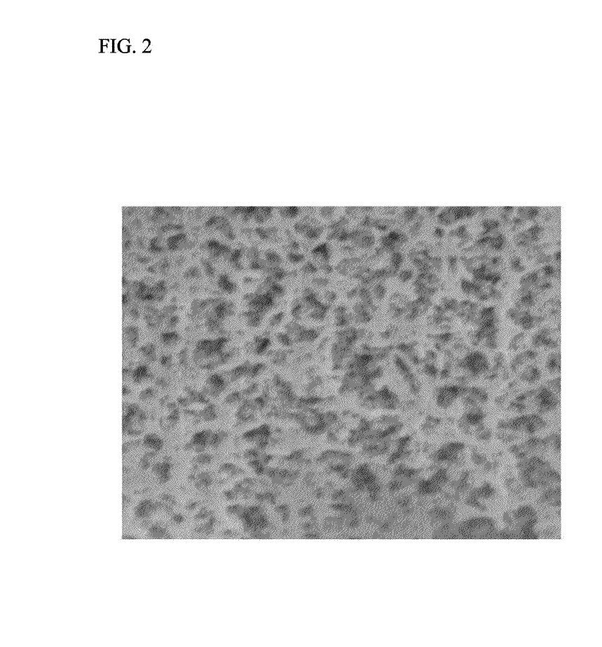

Further, as shown in FIG. 2, within the coating layer produced in Exemplary Embodiment 1, the polyamide imide resin may not permeate into the aerogel and the aerogel may maintain an internal porosity of about 92% or greater. Alternatively, within the coating layer produced in Comparative Example 2, the polyamide imide resin may permeate into the aerogel and pores may be impregnated.

Within the engine radiation noise reduction structure 100 according to an exemplary embodiment of the present invention described above, the coating layer 10 that contains polyamide imide resin and aerogel dispersed within the polyamide imide resin may be formed on the engine cover 1.

Since the engine radiation noise reduction structure 100 according to an exemplary embodiment of the present invention includes the coating layer 10 that has a low thermal conductivity, low volume heat capacity, high mechanical properties, high heat resistance, and high-temperature durability, the coating layer may be applied to the engine cover 1 at a relatively high temperature, may reduce the level of noise emitted from an engine by absorbing noise energy emitted from the engine, and may improve engine and fuel efficiency of a vehicle by reducing thermal energy discharged to the exterior.

In an exemplary embodiment of the present invention, noise energy emitted from an engine may be effectively absorbed, within the range of over about 600 Hz, using the coating layer 10 formed on the engine cover 1. Further, according to an exemplary embodiment of the present invention, the weight of the parts of an engine and the manufacturing cost may be decreased.

While this invention has been described in connection with what is presently considered to be exemplary embodiments, it is to be understood that the invention is not limited to the exemplary embodiments, but, on the contrary, is intended to cover various modifications and equivalent arrangements included within the spirit and scope of the appended claims.

### DESCRIPTION OF SYMBOLS

1 Engine cover
10 Coating layer

What is claimed is:

1. An engine radiation noise reduction structure, comprising:
a coating layer configured to absorb noise emitted from the engine and is formed on a high-temperature noise radiation part that includes an engine cover,
wherein the coating layer contains polyamide imide resin and aerogel dispersed within the polyamide imide resin.

2. The structure of claim 1, wherein the coating layer has a thermal conductivity of 0.60 watts per meter (W/m) or less and a heat capacity of 1250 kilojoules per kelvin (KJ/K) or less.

3. The structure of claim 1, wherein the polyamide imide resin of 2 wt % or less exists within the aerogel.

4. The structure of claim 1, wherein the polyamide imide resin is dispersed within a depth of 5% of a largest diameter from a surface of the aerogel.

5. The structure of claim 1, wherein the aerogel has a porosity of 92% to 99%, when dispersed within the polyamide imide resin.

6. The structure of claim 1, wherein the coating layer has a thickness of 10 millimeters (mm) or less.

7. The structure of claim 1, wherein the coating layer contains the aerogel of about 5 parts by weight to about 50 parts by weight to the polyamide imide resin of 100 parts by weight.

8. The structure of claim 1, wherein the aerogel includes at least one selected from the group consisting of: silicon oxide, carbon, polyimide, and metal carbide.

9. The structure of claim 1, wherein the polyamide imide resin is dispersed within a high-boiling point organic solvent or aqueous solvent and the aerogel is dispersed within a low-boiling point organic solvent.

10. The structure of claim 1, wherein the engine cover is a timing chain cover or a cylinder head cover.
